(19) United States
(12) Patent Application Publication
(10) Pub. No.: US 2005/0289623 A1
(43) Pub. Date: Dec. 29, 2005

(54) Bulk tuning of frequency-modulated video signals

(76) Inventors: Mowaffak Midani, Naperville, IL (US); Ali Taslimi, Petaluma, CA (US); Fazel Taslimi, Petaluma, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/135,010

(22) Filed: May 23, 2005

Related U.S. Application Data
(60) Provisional application No. 60/573,487, filed on May 21, 2004.
(60) Provisional application No. 60/592,258, filed on Jul. 28, 2004.
(60) Provisional application No. 60/614,333, filed on Sep. 28, 2004.
(60) Provisional application No. 60/634,250, filed on Dec. 7, 2004.

(51) Int. Cl. H04N 7/173; H04N 7/16

(52) U.S. Cl. 725/100; 725/131; 725/139; 725/151

(57) ABSTRACT

A video processing engine terminates frequency-modulated video signals transported over the so-called third mile (the network segment from the head-end to the access network) for delivery to an end user. In various network architectures, these signals are received at a central office (CO), for the telephone companies; at a fiber node (FN), for MSOs; or at a satellite dish, for satellite networks. By terminating these signals appropriately, high-quality video service can be delivered efficiently to customers over the last mile. Systems and methods for processing these video streams as well as various network architectures that allow the network providers to offer cost effective video services to the mass market are described.

### CROSS REFERENCE TO RELATED APPLICATIONS

This application claims the benefit of the following provisional applications, each of which is incorporated by reference in its entirety: U.S. Provisional Application No. 60/573,487, filed May 21, 2004; U.S. Provisional Application No. 60/592,258, filed Jul. 28, 2004; U.S. Provisional Application No. 60/614,333, filed Sep. 28, 2004; and U.S. Provisional Application No. 60/634,250, filed Dec. 7, 2004.

### BACKGROUND

1. Field of the Invention

This invention relates generally to the delivery of a media service to customers, and in particular to systems and methods for terminating frequency-modulated video signals and network topologies in which such services may be provided.

2. Background of the Invention

For over one hundred years copper in the form of twisted pair has been deployed by the telephone companies (or carriers) to connect end users (or subscribers) with central office (CO) or remote terminal (RT) equipment to offer standard voice services. With the advent of digital subscriber line (DSL) technology, carriers today offer data services over asymmetric digital subscriber line (ADSL) at rates ranging from 1.5 to 8 Mbps based on the quality of the loop and the subscriber's distance from the CO or RT. It would be desirable for the telephone companies to be able to support triple-play services (video, in addition to voice and data), but the telephone companies have yet to be able to offer profitable and credible video service over their networks.

On the other hand, for decades the multiple service operators (MSOs), also known as the cable companies, have offered broadcast video services over their coaxial network in RF-modulated form. In the last few years, the MSOs have successfully offered high-speed data services as well as voice services using voice-over-IP (VoIP) technology. The MSOs are thus in a good position to offer a complete triple-play package to the end user.

As the carriers and the MSOs compete to capture the lucrative triple-play market opportunity, the carriers are rushing to offer advanced video services over their network while the MSOs are rushing to offer voice and interactive video services in addition to the one-way video broadcast service they offer today. The challenge for the carriers and the MSOs alike is that video service is mostly a broadcast service (one source feeding multiple destinations) and thus requires much more bandwidth than voice and data services.

By its nature, video service is a tiered service where over 80% of subscribers are only interested in and can only afford the basic video broadcast service (i.e., the local channels) and perhaps the subscription-based broadcast video service (i.e., basic cable channels). Video-on-demand (VoD) and near-video-on-demand (NVoD) are prime video services that less than 20% of the population can afford or even desire. It is well understood in the industry that a pure one-way broadcast model is not sufficient for either the carriers or the MSOs and that a combination of broadcast and interactive unicast video services is required for a credible video service offering. But the question remains whether the broadcast channels should be turned into end-to-end unicast channels to have pure IP-based unicast architecture. It is also unanswered whether to optimize the network for the minority unicast traffic in the top 20% of this tiered video service model, or whether to optimize the network for the majority broadcast traffic with provisions for supporting unicast interactive video services.

The question of how to implement triple-play services may also depend on the network architectures currently in place. In the United States, there are four major incumbent local exchange carriers (ILECs) and hundreds of small independent operating companies (IOCs) serving over 100 million subscribers with more than 20,000 central offices (COs). Due to the large addressable market, carriers may deploy a three-stage network to offer the video service. A typical carrier's network includes a national head-end (HE) or super head-end, a number of video head-end/hub offices (VHOs) or video server head-ends (VSHEs), and a number of local COs. Video content is acquired from a variety of sources, including satellite and terrestrial links, and is sent over high capacity network from the national HE to the regional VHOs or VSHEs. Typically, a national HE feeds 40 to 60 VHOs or VSHEs. Each carrier is typically has its own HE, which is mirrored for redundancy. Video content is received from the HE, routed as IP packets to the VHO/VSHE, or stored in video servers for VoD service, and the video content is then distributed to the local COs across a wide region. A VHO or VSHE is expected to feed 20 to 40 local COs. In this way, voice, video and high-speed data are combined (to form triple-play service offering) and sent over the access network to the end users.

Two different network architectures are pursued by the carriers for the access network: fiber-to-the-node (FTTN) architecture and fiber-to-the-premises (FTTP) architecture.

In the FTTN architecture, fiber is used to transport the video content from the HE (i.e., the video source) to the VHOs and then to the COs and RTs. However, copper is used for the last mile (also referred to as the “first mile”) to transport the content from the CO or RT to the end user. To support video, carriers have proposed changing the nature of video service from a predominately broadcast service to an IP-based unicast service, even for the network segments from the HE to the VHOs and from the VHOs to the COs or RTs. In this network architecture, the carriers would be transforming the broadcast video service into an all-unicast point-to-point video service over FTTN network architecture. Every video channel would be stored, transported, managed individually in digital form in a VHO or VSHE, and then pumped downstream towards the subscriber based on a point-to-point VoD IPTV model.

In such an all-unicast IPTV network architecture, video content from satellite links and antennas would be received by a central HE, where analog channels would be digitized and compressed using any of the available video compression techniques (e.g., MPEG-2/MPEG-4, WMV9, or another suitable technique). All channels would then be encapsulated in IP packets and sent to the VHO/VSHE sites over a packet network (e.g., an ATM or IP/MPLS network). At each VHO/VSHE site, the video streams that represent broadcast content would be downloaded into video pump servers and the video streams that represent selective unicast VoD content stored in video servers. Both video pumps and video servers would work on the basis of single-write, multiple-read concept, where a single write stores the video content in the server memory and multiple reads are performed to pump the content for each user selecting to view particular content.

Because a VHO/VSHE site feeds tens of COs, a VHO/VSHE potentially serves hundreds of thousands of end users. A subscriber desiring to view a particular channel would thus make a selection, which selection would be turned into an IGMP message by an XDSL home gateway within the customer's premises and sent upstream towards the network. IGMP is a standard protocol defined by the Internet Engineering Task Force (IETF) for changing video channels. A DSL access multiplexer (DSLAM) would pass the IGMP messages to the CO, which would forward the IGMP message to the video pump/server. The video pump/servers at the VHO/VSHE would terminate the IGMP messages for all users for all channels and pump the selected channel over a dedicated IP stream based on the IPTV point-to-point architecture.

The FTTN architecture approach has major implications on the network from cost and performance points of view, since all the broadcast channels are turned into unicast channels that need to be transported, stored, selected, routed and managed individually. In addition to the video pump expenses in the VHO/VSHE, massive routers would be needed in the CO to route the individual unicast video steams to the end user. The all-unicast IPTV video architecture turns all video traffic into unicast IP streams with a heavy price tag on storage, transport, and control. Another problem is the scale of the all-unicast video streams sent from the HE to the VHOs/VSHEs and then to the COs. This includes high bandwidth requirements at unprecedented level, quality of service for real-time video service guarantees, and multicasting at a massive scale. User plane issues (switching & routing) and control plane issues (signaling) would plague this architecture for years to come and place a heavy toll on deployment cost and service availability

Alternatively, the FTTP architecture has been proposed by a number of carriers. In the FTTP architecture, FTTP access would be deployed using passive optical network (PON) technology in the last mile to offer bundled voice, high speed data, and video services. Video would be delivered to the subscribers in the RF-modulated form similar to the cable TV system, thus allowing for an efficient transport of broadcast video services. The RF spectrum for video is generally divided into three portions. The lower RF spectrum (from 5 to 42 MHz) is used for upstream signaling and is also known as the return path; the middle RF spectrum (from 42 to 550 MHz) is used to carry analog video channels downstream toward the subscriber; and the upper RF spectrum (from 550 to 860 MHz) is used to carry quadrature amplitude modulation (QAM) digital video channels downstream. As the industry moves toward digital video, it is expected that more downstream spectrum will be allocated to digital video at the expense of the analog spectrum and above the 860 MHz mark.

One issue that is emerging with this approach is the difficulty of transporting the QAM-modulated RF video signal over long haul (distance) in the backbone network. This is forcing the carriers to transport the video signal in base-band format over expensive SONET-based networks from the HE to the VHOs/VSHEs and the COs and to perform QAM modulation locally at each CO. There is no technical value gained in transporting the video signal in base-band format from the HE to the VHOs/VSHEs and from the VHOs/VSHEs to COs, and, in fact, the carriers would prefer centralized QAM processing in the HE or in the VHOs/VSHEs if it were possible to transport the QAM signal over a long haul in a cost effective way. However, there is currently no cost effective way to perform QAM regeneration between the HE and the VHOs/VSHEs and between the VHOs/VSHEs and the COs, so the carriers reluctantly transport the video content in base-band to the VHOs/VSHEs and the COs. This problem adds to the cost of offering triple-play services over last mile FTTP network.

With the FTTP network architecture, if base-band is used for long haul video transport, the problem of the additional cost of the SONET network in the third mile segment (i.e., the transport network from the HE) arises. Alternatively, if RF is used for long haul transport, the problems of the cost and questionable quality of amplifying the QAM signal with existing technology arise. In both cases, the impact on the carrier is negative and can be very significant.

While the carriers pursue FTTN and FTTP architectures, the MSOs have pursued other architectures to improve triple-play services. The MSOs use a combination of fiber and coaxial cables to deliver video services. Fiber is used to deliver broadcast video content in RF-modulated form from the HE to the fiber nodes (FNs), and coaxial cables is used as last mile transport technology to carry the video content from the FN to the end users. The entire broadcast stream (all channels) is delivered to the users over this hybrid fiber coax (HFC) network. Customer premises equipment (CPE), in the form of a set-top-box (STB), is used by the end user to tune to the desired program (channel).

In the last 5-10 years, the MSOs have enhanced their HFC network to offer IP-based data services using the same downstream RF-modulated technology used for the video service and time division multiple access (TDMA) technology for the upstream traffic. This method is referred to as data over cable service interface specifications (DOCSIS) and is provided via cable modem termination system (CMTS) equipment in the HE. Disadvantageously, the MSOs' architecture suffers from a lack of sufficient interactivity and a fixed bandwidth (or channel) allocation from the FN to the end user (as channel allocation for video and data is fixed in today's CATV plan).

The last major mass delivery system for video is the broadcast video satellite system. In a broadcast video satellite system, video content is broadcasted from a satellite in orbit and received by satellite dishes in the serving areas. This is generally a one-way broadcast service in nature, although with the introduction of personal video recorder (PVR) technology some interactivity may be provided to the end user. A major problem with broadcast video satellite systems is the long time it takes to change channels (known as the zapping time). This delay is caused by the time it takes to tune to a different channel and the MPEG decoding process performed at the customer's receiver or STB.

Accordingly, each of the network architectures for the delivery of video service that are currently proposed or currently in use has inherent problems and shortcomings.

### SUMMARY OF THE INVENTION

Methods and systems are therefore provided to address the technical constraints associated with mass delivery of multi-channel video service over various network architectures. To solve these problems, an embodiment of a video processing engine terminates frequency-modulated broadcast video signal transmitted from the head-end over the so-called third mile (the network segment from the head-end to the access network) for delivery to an end user. In various network architectures, the signal is received at a central office (CO), for the telephone companies; at a fiber node (FN), for MSOs; or at a satellite dish, for satellite networks. By terminating the entire frequency modulated broadcast signal, individual video program streams (PS) within the entire frequency range are extracted in baseband digital form and IP-based video service can be delivered efficiently to the customers over the bandwidth constrained last mile. Embodiments of the invention thus include systems and methods for processing these video streams as well as various network architectures that allow the network providers to offer cost effective video services to the mass market.

In one embodiment of the invention, a video processing engine tunes to multiple wideband frequency channels in the analog domain, generates multiple pipelines or flows, performs analog to digital conversion for each pipeline, and performs digital signal processing to extract the sub-carriers or channels to produce the digital video content or program streams. Based on a distributed and parallel processing approach, the video processing engine can process hundreds of video channels (or sub-carriers) and thousands of video program streams simultaneously.

In one embodiment of the invention, a video processing engine receives a frequency-modulated video signal that contains a plurality of frequency channels with digital video content modulated in the channels. The video processing engine converts the received video signal from the analog to the digital domain, extracts a plurality of channels from the video signal by using de-channelization in the digital domain, and then demodulates the digital video content from the extracted channels. In this way, the video processing engine produces a plurality of encoded digital video program streams from the received frequency-modulated video signal. The video processing engine may perform all or any portion of the processing on the received video signal in parallel by first dividing the signal into a plurality of wideband frequency components and then performing the processing in a corresponding plurality of video pipes. This allows for scaling of the capabilities of the video processing engine, for example to accommodate any limitations in the hardware components of the engine.

Embodiments of the invention also include various network architectures for delivering video to customers over a telephony network. Applications of the video processing engine include applications as a stand-alone video engine, as a part of a multi-service access platform, as a video QAM repeater, and as a front-end for a STB for satellite TV. Network topologies in which these or other embodiments of the video processing engine can be used include various configurations of fiber-to-the-node (FTTN), fiber-to-the-premises (FTTP), cable TV (CATV), video over DOCSIS, and satellite TV network architectures.

### BRIEF DESCRIPTION OF THE DRAWINGS

FIG. 1 illustrates the stages of signal processing performed in a video pipe of one embodiment of the video processing engine.

FIG. 2 is a schematic diagram of a video processing engine, in accordance with an embodiment of the invention.

FIG. 3 is an illustration of the frequency bands processed in an example implementation of a video processing engine, in accordance with an embodiment of the invention.

FIG. 4 is a diagram of the frequency band processing for a video pipe, in accordance with an embodiment of a video processing engine.

FIG. 5 is a schematic diagram of a video processing engine implemented as a stand-alone video engine, in accordance with an embodiment of the invention.

FIG. 6 is a schematic diagram of a video processing engine implemented as part of a multi-service access platform, in accordance with an embodiment of the invention.

FIG. 7 is a schematic diagram of a video processing engine implemented as a video QAM repeater, in accordance with an embodiment of the invention.

FIG. 8 is a schematic diagram of a video processing engine implemented as a front-end for a set-top-box for a satellite network, in accordance with an embodiment of the invention.

FIG. 9 illustrates a technique for L-band slicing for satellite bulk tuning, in accordance with an embodiment of the invention.

FIG. 10 is a diagram of the frequency band processing for an L-band video pipe in a satellite network, in accordance with an embodiment of a video processing engine.

FIG. 11 is a schematic diagram of a fiber-to-the-node (FTTN) network architecture, in accordance with an embodiment of the invention.

FIG. 12 is a schematic diagram of a fiber-to-the-premises (FTTP) network architecture, in accordance with an embodiment of the invention.

FIG. 13 is a schematic diagram of a fiber-to-the-premises (FTTP) network architecture, in accordance with an embodiment of the invention.

FIG. 14 is a schematic diagram of a cable TV (CATV) network architecture for business deployments, in accordance with an embodiment of the invention.

FIG. 15 is a schematic diagram of a cable TV (CATV) network architecture for remote site deployments, in accordance with an embodiment of the invention.

FIG. 16 is a schematic diagram of a video over DOCSIS network architecture, in accordance with an embodiment of the invention.

FIG. 17 is a schematic diagram of a satellite TV network architecture, in accordance with an embodiment of the invention.

### DETAILED DESCRIPTION OF THE PREFERRED EMBODIMENTS

Described herein are embodiments of a video processing engine for processing frequency-modulated video signals for delivery to customers over one or more of a variety of network architectures and in a number of applications. The video processing engine terminates the frequency-modulated video signal and processes it for delivery to customers over the last mile of the network to the customer premises. The video processing engine may be adapted for any of a number of different network architectures. For example, the video processing engine may terminate the video signal received at a central office (CO) for a telephony network, at a fiber node (FN) for a MSO-operated cable network; or at a satellite dish for a satellite network. In addition, the video processing engine may be implemented in a number of different applications, for example, as a stand-alone video engine, a multi-service access platform, a video QAM repeater, a front-end for a set top box (STB) for a satellite TV system, or in any of a number of other applications. Also described are various network topologies in which embodiments of the video processing engine can be applied.

Video Processing Engine

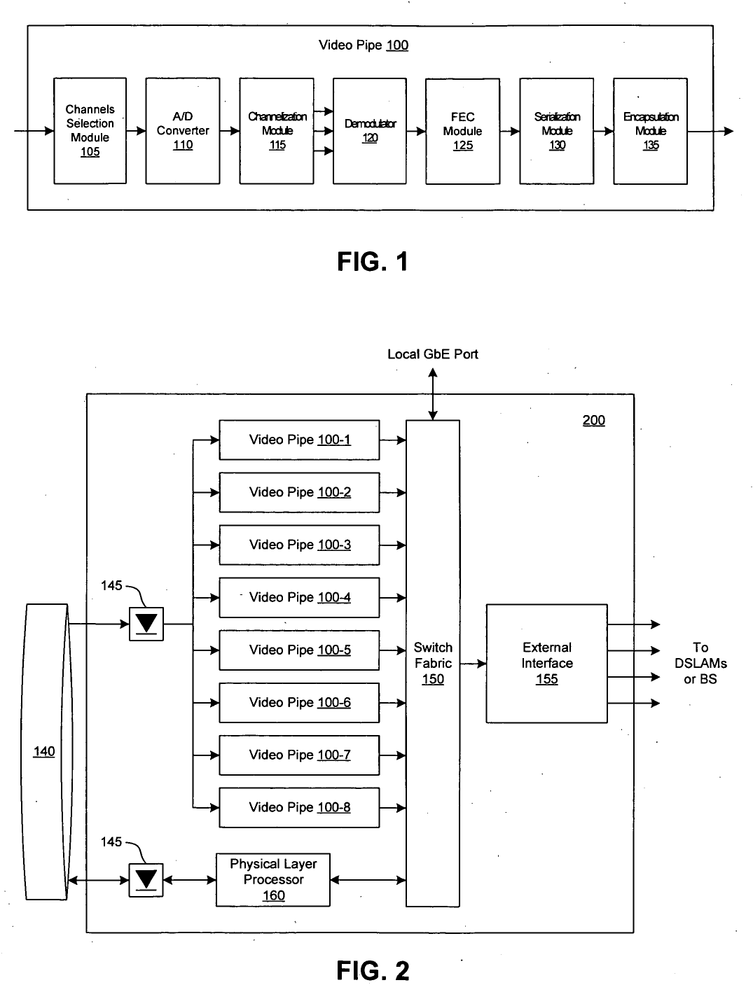

In one embodiment, a video processing engine is used to tune to multiple wideband frequency channels in the analog domain, generate multiple pipelines or flows, perform analog to digital conversion for each pipeline, and then perform digital signal processing to extract the sub-carriers or channels to produce the digital video content or program streams. Based on a distributed and parallel processing approach, the video processing engine can process hundreds of video channels and thousands of program streams simultaneously. FIG. 1 illustrates the stages of signal processing performed in a video pipe by an embodiment of the video processing engine, which is shown diagrammatically in FIG. 2 processing a plurality of video pipes in parallel.

FIG. 1 is a diagram of a video pipe 100 of the video processing engine 200 of FIG. 2, which typically includes a plurality of video pipes 100 for processing different frequency bands of a video signal in parallel. As illustrated, the video pipe 100 receives a frequency-modulated video signal having a wide bandwidth of “N” MHz. To process the video signal and extract a number of the video streams encoded therein, the video pipe 100 in accordance with one embodiment includes a channels selection module 105, and A/D converter 110, a channelization module 115, a demodulator 120, a FEC module 125, a serialization module 130, and an encapsulation module 135.

The channels selection module 105 is coupled to receive the incoming N-MHz video signal. In the channels selection module 105, multiple wide frequency bands with a wide bandwidth of N MHz are located and extracted from the overall frequency spectrum using a number of bandpass filters. This extraction is performed in a bulk mode, as multiple sub-carriers are extracted together from each bandwidth of N MHz. The covered range depends on the type of modulated signal in the incoming video signal, which for example could be RF for cable TV or L-Band for satellite TV. Preferably, the channels selection module 105 applies down conversion in the analog domain to bring the frequencies in the channels down to a workable level.

Each down-converted wideband analog channel passes from the channels selection module 105 to a wideband A/D converter 110, which converts the analog channel into a digital signal. So that the video content in the analog signal can be fully recovered, it is sampled at twice the highest frequency rate in the signal. Preferably, multiple A/D converters 110 are used in parallel in the video processing engine 200, e.g., one for each video pipe 100, to accommodate the large number of channels in the frequency spectrum.

The digitized video signal is then passed to the channelization module 115, which applies digital channelization processing to the sampled digital signals. This process separates the individual sub-carriers (e.g., 6 MHz, 8 MHz, or 30 MHz, based on the type of received signal) in the digital domain. Each of the extracted digital sub-carriers is then passed to the demodulator 120. In one embodiment, the demodulator 120 performs quadrature amplitude modulation (QAM) or quadrature phase shift keying (QPSK) demodulation to apply matching filters to identify and extract the symbols from the digital signal.

In one embodiment, the output symbols from the demodulator 120 are passed through a forward error correction (FEC) module 125 to correct any transport errors. The corrected symbols from the FEC module 125 may represent a video signal in MPEG, WMV9, or another appropriate video encoding format. In some implementations, this encoded video signal represents multiple MPEG (or other format) transport streams multiplexed over the same sub-channel. In such a case, the video signal can be passed through a serialization module 130, which assembles the MPEG transport streams based on their program ID value (PID). The result of this process is a set of video streams that correspond to each of the encoded video streams in the original incoming N-MHz frequency band of the received video signal.

Once the processing of each encoded program stream is completed, checked, and serialized (if necessary), each program stream is encapsulated by an encapsulation module 135. In one embodiment, the encapsulation module 135 receives each program stream—encoded in MPEG, WMV9, or another video encoding format—and encapsulates the individual program stream into a series of IP packets. The IP packets for each program stream can then be routed to appropriate destinations on the access network by the video processing engine 200, as described below.

With reference to FIG. 2, a video processing engine 200 may include a plurality of video pipes 100-n (in the illustrated example, shown as 100-1 through 100-8), each one for performing the extraction process shown in FIG. 1. The addition of video pipes 100-n allows the video processing engine 200 to be scaled up for processing a greater number of channels. In a typical configuration, the video processing engine 200 receives a video signal from a network 140, such as an optical network on a 1550-nm wavelength carrier. An analog receiver 145 obtains the signal from the network 140 and provides the incoming signal to each of the video pipes 100-n in the video processing engine 200. Each of the video pipes 100-n is configured to select a portion of the frequency band of the received video signal for processing. In this way, the video pipes 100-n can share the processing load, each one extracting a portion of the video content from the video signal broadcast over the network 140. The product of the parallel video pipes 100-n may comprise thousands of video program streams made available for routing to various destinations. In this way, the process may be thought of as “bulk tuning” or “mass tuning” of the incoming broadcast signal.

The program streams extracted from the video pipes 100-n may be provided to a switch fabric 150 for delivery. The switch fabric 150 is coupled to an external interface 155, which routes the packetized program streams to subscribers via an appropriate network interface. Depending on the network architecture, of which several are described below, the external interface 155 may route the program streams to subscribers via a DSLAM or directly to a subscriber's broadcast receiver BS.

In addition to the one-way video processing performed in the video engine 200 by the video pipes 100-n, the video processing engine 200 may include a path to accommodate any unicast video stream over a separate wavelength. As shown in FIG. 2, this path is for signals received from the network 140 via an analog receiver 145 and processed by a physical layer processor 160. The received signal is in base-band (i.e., it is not modulated), so it need not be tuned or demodulated by a video pipe 100-n as described above. This path allows for unicast video, VoIP, and/or data to be exchanged between the service provider and the subscriber.

In one embodiment of the video processing engine 200 shown in FIG. 2, signaling and control (i.e., control plane processing) can be performed based on IPTV. For example, control requests received from the subscriber (such as channel change requests) may be transmitted to the video processing engine 200 via Internet Group Management Protocol (IGMP) messages according to the IETF standard specification. The video processing engine 200 routes the requested program stream to the subscriber according to the subscriber's requests. In this way, entire video broadcast stream need not be sent over the last mile (e.g., copper, coax, or wireless) from the video processing engine 200 to the customer premises infrastructure; only the user-selected and switched video program streams are sent downstream to the subscribers. Beneficially, switching of the packetized program streams may be performed by the video processing engine 200 at the Ethernet packet level based on dynamically configured multicast groups in response to IGMP messages from the subscribers. The video processing engine 200 thus terminates the entire frequency modulated video broadcast service from the head-end and provides true, local, and economical switched digital video (SDV) service to the individual users over the access network.

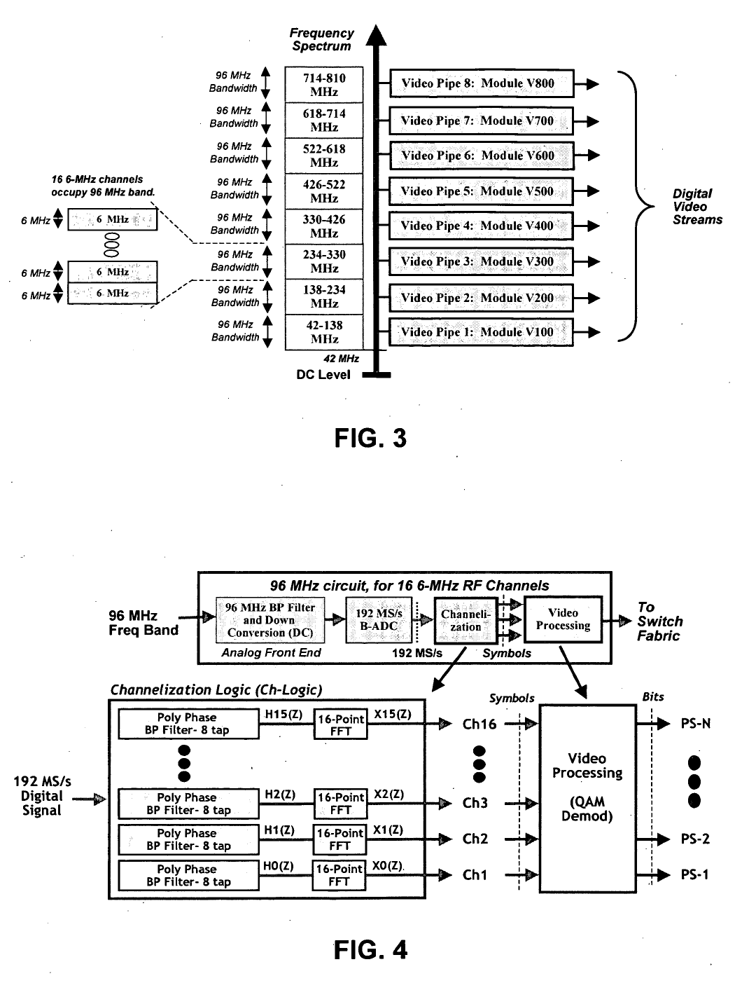

One implementation of the video processing engine 200 is shown in FIG. 3. In this example implementation, eight frequency bands, each having a 96-MHz width, are extracted from an overall 42-MHz to 860-MHz RF frequency spectrum. Each of the eight frequency bands are processed simultaneously in eight parallel video pipes 100-n. According to the RF plan in the United States, the 96-MHz band includes sixteen 6-MHz sub-carriers. (In Europe, each sub-carrier is 8-MHz wide, so a 96-MHz band in Europe would include twelve 8-MHz sub-carriers.) Accordingly, in one implementation of the video processing engine 200 for the United States, each pipeline 100-n would include a 192-MS/s A/D converter 110 for sampling the 96-MHz signal. The channelization module 115 would separate the sixteen sub-carriers in the digital domain, and each channel would be passed through the demodulator 120 to produce the program streams. With sixteen 6-MHz sub-carriers in each 96-MHz band, over 135 6-MHz sub-carriers could be processed in the video processing engine 200. With fifteen standard definition television (SDTV) or six high definition television (HDTV) video programs modulated per 6-MHz sub-carrier (assuming 256 QAM modulation and MPEG-4 encoded), over 2000 SDTV or 800 HDTV streams could be supported in such a video processing engine 200. An example of this processing for one video pipe 100 is illustrated in FIG. 4.

Although the video processing engine 200 has been described and illustrated as having eight video pipes 100, other embodiments of the video processing engine 200 may have fewer or more video pipes 100, and in another embodiment there is only a single video pipe 100 or processing path. Using the video pipes 100, the video processing engine 200 may perform all or any portion of the processing on the received video signal in parallel by first dividing the signal into a plurality of wideband frequency components and then performing the processing in a corresponding plurality of video pipes 100. This allows for scaling of the capabilities of the video processing engine, for example to accommodate any limitations in the hardware components of the engine. For example, existing analog to digital converters may not be able to handle the throughput required to process an entire video signal. To avoid this technical limitation, the received video signal may be dived into frequency components and a number of analog to digital converters used in parallel on the components.

Applications

As described herein, the video processing engine 200 can be implemented in various applications. Some of the applications include a stand-alone video engine, a multi-service platform, a video QAM repeater, and a front-end for a set-top-box for satellite TV.

Stand-Alone Video Engine

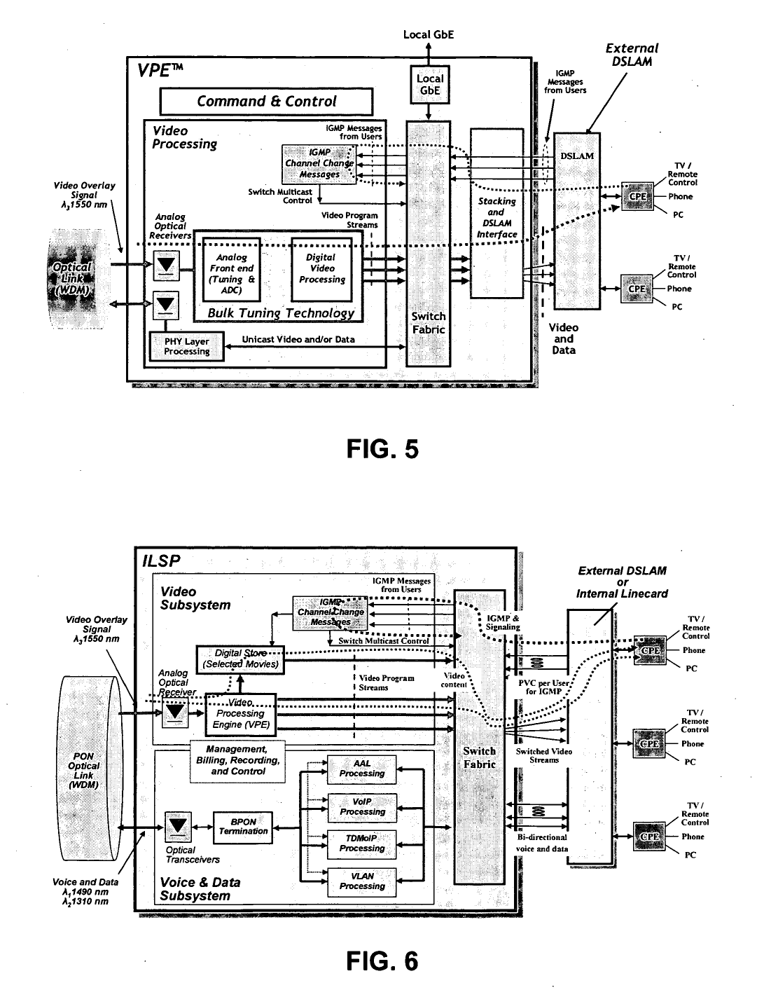

In one embodiment, the video processing engine 200 is built as a stand-alone video-only system. As shown in FIG. 5, in such an implementation, the video processing engine 200 may reside behind a DSLAM. Alternatively, the video processing engine 200 may reside behind a base station, a router, or a cable modem termination system (CMTS). Accordingly, while the video processing engine 200 may be part of a larger system, it can also be implemented as a stand-alone system of itself.

Multi-Service Access Platform

In another embodiment, the video processing engine 200 is built as part of a multi-media multi-service access platform, shown in FIG. 6. As existing multi-media multi-service access platforms do not handle video, an embodiment of a video-enable multi-service access platform that can process video may be referred to as an integrated loop services platform (ILSP). In this implementation, the video subsystem portion of the video processing engine handles the video bulk/mass tuning function. The voice and data subsystem handles other media forms, such as voice (e.g., VoIP), time-division multiplexing over IP (TDMoIP), ATM data (e.g., ATM adaptation layer or AAL function), and/or virtual local Area network (VLAN) data. The video processing engine can be built as a subsystem (e.g., as a blade) inside a DSLAM, a base station, a router, or a CMTS as required by the network.

Beneficially, application of bulk tuning to a multi-service access platform results in an integrated access platform that supports triple-play services in a cost effective way, thereby enabling the carriers to compete with the MSOs.

Video QAM Repeater

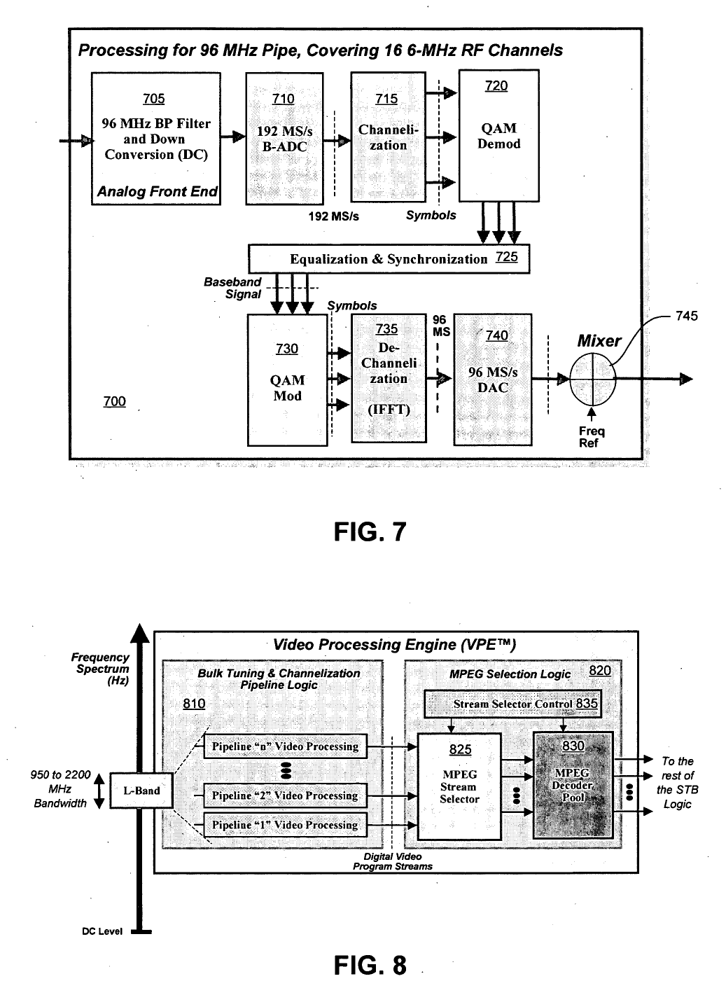

In network architectures in which video is transported over long haul transport network in QAM over RF form (QAM/RF), signal repeaters must be used every 50 to 60 miles to amplify the signal. Existing technology uses analog amplification of the entire RF signal using Erbium-Doped Fiber Amplifiers (EDFA), but unfortunately this technique amplifies the noise in addition to the useful signal. To avoid this problem, a bulk tuning process as described herein is applied to the signal instead, where the useful video signal is tuned to, extracted, digitized, regenerated, and then put back into RF form. In this way, the video signal can be amplified without amplifying the noise. A system for performing this process, which can be termed a video QAM repeater 700, is illustrated in FIG. 7.

The video QAM repeater 700 terminates the physical layer on the fiber link, performing optical to electrical (O/E) conversion to extract the electrical RF signal. The repeater 700 then separates the lower RF portion (analog video portion) of the downstream spectrum from the upper RF portion (digital video portion) of the downstream spectrum using a bandpass filter 705. The signal is then sampled in an A/D converter 710, passed through channelization module 710, and then demodulated in a demodulator 715, as described above in connection with the video pipe 100 in FIGS. 1 and 2. The result is a set of MPEG transport streams, or program streams encoded in another format, for the video content in the received signal. As described above, this video processing may be performed in parallel on different portions of the incoming signal bandwidth by a number of parallel video processing pipes.

In one embodiment, the program streams are processed by an equalization and synchronization module 720 to clean the program streams. The video QAM repeater 700 then performs the reverse process to modulate the streams for transmission over the transmission medium. For example, the repeater 700 may perform QAM modulation is applied to the program streams in a QAM modulator 725, followed by channel combining (e.g., using the de-channelization process defined by the IFET) in a de-channelization module 730. In a typical United States implementation, the result of the de-channelization process is a 96-MHz digital signal. This signal is then converted to analog in a D/A converter 735 (e.g., a 96 MS/s converter circuit). In an implementation where the transmission signal is processed in a number of parallel pipes, the divided signals from the pipes are then combined in the RF domain using an analog mixer circuit 740. The result is a re-generated QAM/RF signal without the noise being amplified.

In one embodiment, no digital processing is performed for the analog (lower) portion of the spectrum (besides that related to optical-electrical conversions), but extensive digital signal processing is performed for the digital and QAM-modulated (upper) portion of the spectrum. After regeneration of the QAM portion of the video signal, the analog and digital video signals are recombined in the frequency mixer circuit 740. The combined electrical signal can then be converted to an optical signal using any of a variety of known electrical to optical (E/O) devices for transmission over an optical link.

In one embodiment implemented in current standards, the entire RF video spectrum includes over 135 6-MHz frequency sub-carriers. In this embodiment, only one analog video channel can be carried in a single 6-MHz sub-carrier, while up to fifteen digital video channels can be carried in any single 6-MHz sub-carrier (if MPEG-4 is used as the encoding technique). The boundary or cut-off frequency between the analog and digital video signals is adjustable, thus allowing the carrier gradually to claim more RF spectrum for digital video. Eventually, it is expected that the entire spectrum will be used to transport digital video, and the cut-off frequency would become the low frequency of the overall video RF spectrum (42 MHz). The bandpass filter 705 in the repeater 700 can be adjusted to accommodate any change in this cut-off frequency.

The video QAM repeater 700 can be applied in a number of network architectures, including a FTTP network architecture when the video signal broadcasted in QAM over RF form from the HE to the COs (also know as the super trunk architecture). It can also be applied in a MSO network architecture, where video is transported naturally in QAM over RF form.

Front-End for Set-Top-Box for Satellite

To eliminate the long delay associated with channel changing (zap time) in a satellite TV environment, tuning and MPEG decoding times should be taken out of the critical time during channel change, which was heretofore impossible with previous technology. Using bulk tuning and the MPEG video processing techniques described herein, however, these times can be significantly shortened. Moreover, by tuning to all the channels in the L-Band frequency spectrum and extracting all digital program streams, a set-top-box (STB) has the ability to store some or all the program streams, in digital baseband form, in a local cache for viewing at any time, thus providing personal video recorder capability for any channel in the frequency spectrum.

In one embodiment of this technique, illustrated in FIGS. 8-10, a bulk tuning process is performed as a front-end of a STB for a satellite TV network. This could physically reside within the STB enclosure itself, or it could reside in a separate front-end unit located between the dish and the STB unit. By tuning to all the incoming channels in the L-Band spectrum, providing a sufficiently large MPEG decoder pool, and providing predictive look-ahead control logic for the next channel to be selected by the user, video content can be made available instantly for the end user. This is because video program channels of interest are tuned to and decoded even before the user selects the content by changing the channel.

In one embodiment, a STB for a satellite TV system includes a video processing engine 810 as described herein. As illustrated in FIG. 8, the video processing engine 810 acts as a front-end to the STB, whether located internally or externally to the STB unit. The video processing engine 810 includes a plurality of video pipes that perform bulk tuning and channelization, as described above. The digital video program streams from the bulk tuning are then provided to a stream selector module 820. The stream selector module 820 includes a stream selector 825 to receive the program streams and provides the streams to a MPEG decoder pool 830, which selectively decodes the streams. If the video content is encoded using another video encoding standard, the decoder pool 830 is configured to decode the streams according to that other standard. A predictive logic or stream selector control 835 sends control signals to the stream selector module 820 and MPEG decoder pool 830. In this way, which channels (e.g., in the range of 32 to 64 channels) are to be MPEG-decoded among the possible thousands of program streams is determined.

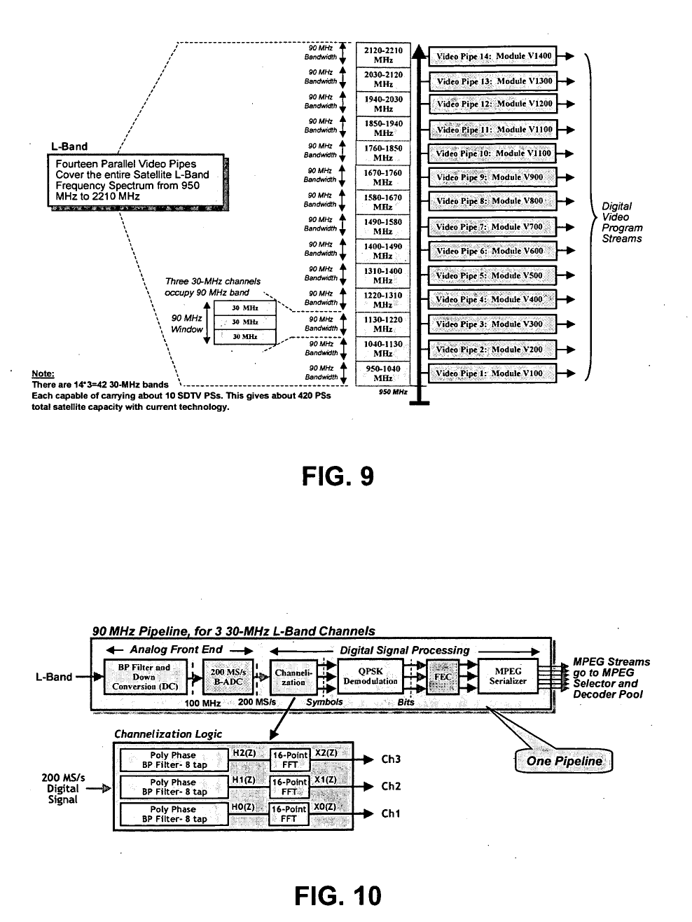

FIG. 9 illustrates how the L-band's spectrum can be sliced in accordance with one embodiment of the invention. In a typical satellite TV system, there are 42 30-MHz bands. Each of these bands is capable of carrying about ten SDTV program streams, yielding about 420 program streams total satellite capacity with current technology. However, more video pipes could be added to accommodate an extension of the frequency spectrum beyond 2,200 MHz.

FIG. 10 illustrates the design of a single video pipe for use in a STB for a satellite system. In one embodiment, this video pipe processes the video signals as generally described above, where the wide band received by the video pipe is 90 MHz in width, there are three 30-MHz sub-carriers in the wide band, and QPSK demodulation is used instead of QAM demodulation. As in the RF case, the A/D converter as a sampling rate of at least twice the highest frequency rate to avoid aliasing.

Network Architectures

From this discussion it can be appreciated that bulk tuning of frequency-modulated video signals can be applied in a number of applications. In addition, this technology can exist in any number of network architectures, from those run by the carriers (i.e., the telephone companies), those by the MSOs (i.e., the cable TV operators), and in systems run by video broadcast satellite operators. While there is no limit to the architectures in which the bulk tuning process can be employed, a number of specific systems are described herein.

Fiber-to-the-Node (FTTN)

Existing fiber-to-the-node (FTTN) topologies unicast all the video channels in individual IP streams across a packet network, as described above. These systems store the video channels in digital packet form in a massive and expensive complex of video servers at the VHOs/VSHEs and then transport and route the individual IP streams from the VHO/VSHE to the thousands of COs. To avoid the inherent inefficiencies of such a system, the broadcast video channels (the majority of the video content) can be RF-modulated at the VHO/VSHE site, and the channels can be broadcast to the COs in their native MPEG over QAM over RF form. (It is noted that RF modulation can also take place in the head-end, in which case video would be distributed over WDM network to all the VSHEs and COs.) The video signals can then be demodulated and processed for delivery over the last mile by a video processing engine as described herein. In such an embodiment, only selected video streams targeted for the VoD service (typically, less than 10 to 20% of the total video traffic) would be stored and managed individually in the video servers at the VHO/VSHE, thus reducing the cost and complexity of storing and managing the video content across the network.

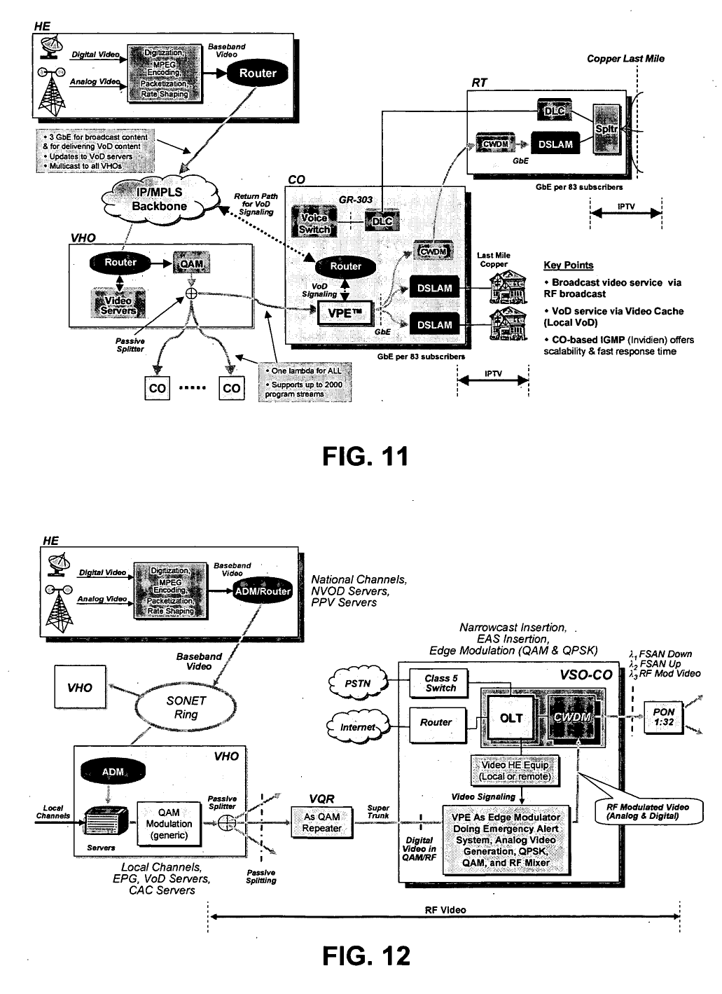

FIG. 11 is a diagram of a FTTN network topology that incorporated bulk tuning in accordance with an embodiment of the invention. In the implementation of this architecture shown, the broadcast channels constituting the majority of the video traffic is RF-modulated within the 42-MHz to 860-MHz frequency spectrum in their respective 6-MHz sub-carriers. This modulation is performed at the VHO/VSHE site using QAM. The modulated video signals are then transported to the COs and/or RTs as broadcast streams over fiber links on a dedicated wavelength.

Each CO or RT cabinet includes a video processing engine 200, such as that described in connection with FIGS. 1-2. The video processing engine 200 receives the broadcast RF-modulated video and extracts the individual digital video program streams. Selected video program streams are sent to the subscribers via DSLAM equipment in response to IGMP messages received from the subscribers. In this way, unicast video traffic originating from the VHONSHE passes through the video processing engine 200 transparently to the DSLAM for routing to the end user. From the VHOs/VSHEs to the COs/RTs, most of the video traffic (typically, over 80%) is sent in a broadcast fashion over a RF-modulated signal, thereby reducing the overhead and costs associated with transmission of digital IP streams.

Beneficially, this embodiment of a FTTN architecture may be implemented with the same processing of analog and digital channels at the HE and at the customer premises as compared to previous FTTN architectures. This avoids the need to invest in new equipment at the HE or at the customer premises. In addition, a common video processing front-end is possible for all video services in the HE, including receiving the content from the content providers (e.g., via satellite or antenna links) and performing digital compression (e.g., MPEG or WMV9). The signaling protocol for video channel selection based on standard IGMP messages may also be the same.

It is also noted that in this embodiment, the VHOs/VSHEs broadcast video can be RF-modulated and sent over the Wavelength Division Multiplexing (WDM) network on the fly (via the QAM device at the VHO/VSHE). There is therefore no need to deploy the single-write, multiple-read video pumps to store the content, and there is no point of contention at the video pump(s) in handling a large amount of IGMP messages (especially during prime time and commercials). Moreover, the VoD service can be decoupled from the broadcast service, so carriers can choose to offer broadcast services without deploying a single video sever in their network and then add value-added capability at later stages. Given the complexity and cost of the video pumps/servers in the all-unicast network architecture, removing the video server technology from the critical path reduces deployment risks. Lastly, the IGMP termination can be distributed to the video processing engines rather than being deployed in a centralized way. Decentralizing this task allows for faster channel change response time and facilitates network growth and scalability.

Accordingly, the use of bulk tuning at the CO or RT as described herein capitalizes on the efficiency of the QAM and RF video modulation during the transmission of the video signal to the CO/RTs. The video processing engine's capability in switched digital video (SDV), IGMP, video server technology, and bulk tuning allows for an efficient FTTN network architecture in which tiered video services can be offered to the mass market over a telephony network. Although the last mile in this architecture is described as a copper-pair telephone connection, the last mile could also be served by fixed wireless or any other technology that is available for sending the program streams to the subscriber and receiving the control messages from the subscriber. Such new technologies could be implemented for the last mile, typically without requiring any significant modifications to the video processing engine.

Fiber-to-the-Premises (FTTP)

FIG. 12 illustrates a FTTP network architecture in which the video signal is transported to the customer premises over an optical fiber link, in accordance with an embodiment of the invention. Because such an architecture may involve the transmission of the video signal over long distances, embodiments of this architecture use a video QAM repeater such as the one described above. The network in FIG. 12 is a QAM-based video network that allows the carriers to transport a QAM-modulated RF-based video signal over long distances. This system permits the carriers to centralize QAM modulation in the VHOs/VSHEs and transport the QAM video signal to the thousands of COs across the country in a more cost-effective way.

With QAM modulation performed at the VHO/VSHE, passive splitters can be used to duplicate the RF signal at the VHO/VSHE for transmission to the COs with significant savings in capital and operational expenditures. When the distance between a CO and its parent VHO/VSHE exceeds certain length, one or more video QAM repeaters are placed in the path to regenerate the QAM signal.

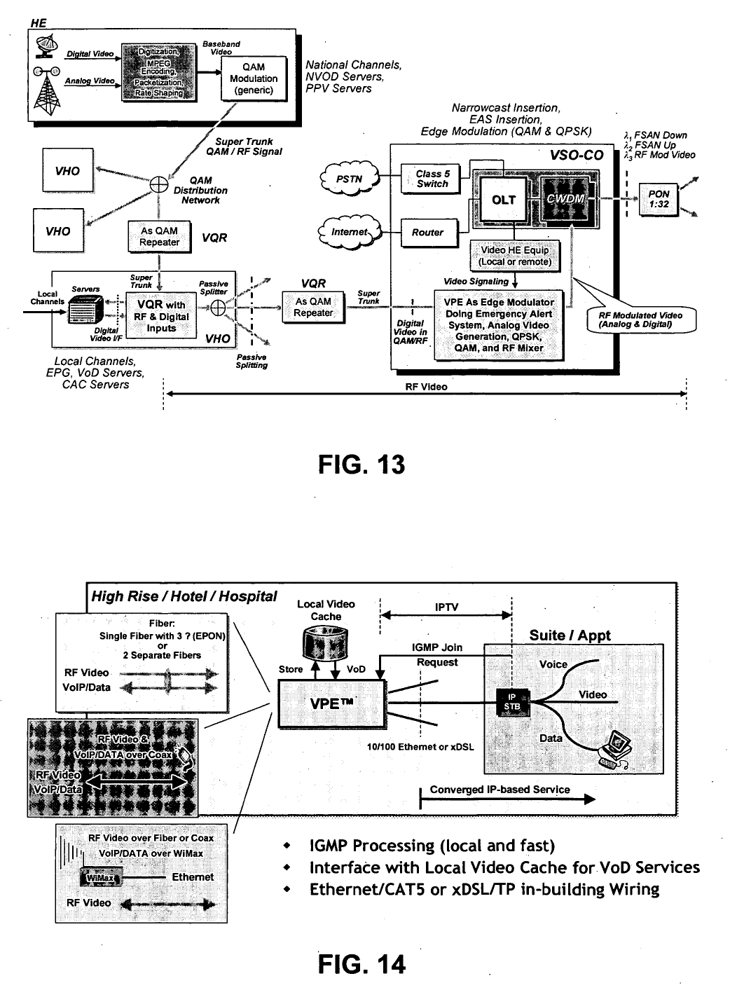

In another embodiment, shown in FIG. 13, the video signal is QAM-modulated at the HE and transported to the VHOs/VSHEs and to the CO/RTs as a QAM-modulated RF-based video signal. Moving the QAM function all the way to the HE completely eliminates the SONET ring between the HE and the VHOs/VSHEs. With this network architecture, the VHOs/VSHEs and COs are greatly simplified, and there is no need to deploy expensive SONET network. As with the architecture shown in FIG. 12, one or more video QAM repeaters are placed in the paths between the HE and VHOs/VSHEs and between the VHOs/VSHEs and CO/RTs to regenerate the QAM signal.

Cable TV Network (CATV)

MSOs can also use the bulk tuning technology described herein to offer converged IP-based triple-play services that are VoIP, IP data, and video over IP (VIDoIP) over point-to-point IP links to the end user. A network architecture in accordance with an embodiment of the invention allows the MSOs to combine RF modulation, IP, IPTV, IGMP, xDSL, fixed wireless and/or point-to-point Ethernet to offer triple-play services in a cost effective way. This architecture avoids the need to broadcast the entire video content to the end user, which requires a coaxial cable to the last mile.

In one embodiment, shown in FIG. 14, a CATV network architecture is shown designed for business environments, including residential high rises, hospitals, universities, and multiple units and multiple tenant units deployments. In this embodiment, a video processing engine resides in a building, hospital, or hotel, for example in the basement of the building. The video processing engine receives voice, data, and video traffic over any available long haul technology or medium, which may include fiber, coaxial cable, or wireless. The video is received in its standard RF-modulated form, and voice and data are received in their IP forms.

The video processing engine performs bulk tuning on the incoming video signal, in accordance with the techniques described herein. As a result, the video processing engine converts the video signal to base-band, so all three types of traffic are in IP form. This traffic can then be forwarded to the end user. Voice and data flows are forwarded transparently based on IP addresses, and video flows are forwarded based on IGMP messages—effectively marrying the best of IPTV technology with RF technology. Advantageously, the last mile transport is basically point-to-point, without sacrificing the efficiency and cost-effectiveness of RF-based network feed and without limiting the wide program selection on a cable system. Moreover, the end user receives all services over IP packets, allowing for full convergence of services in the IP paradigm.

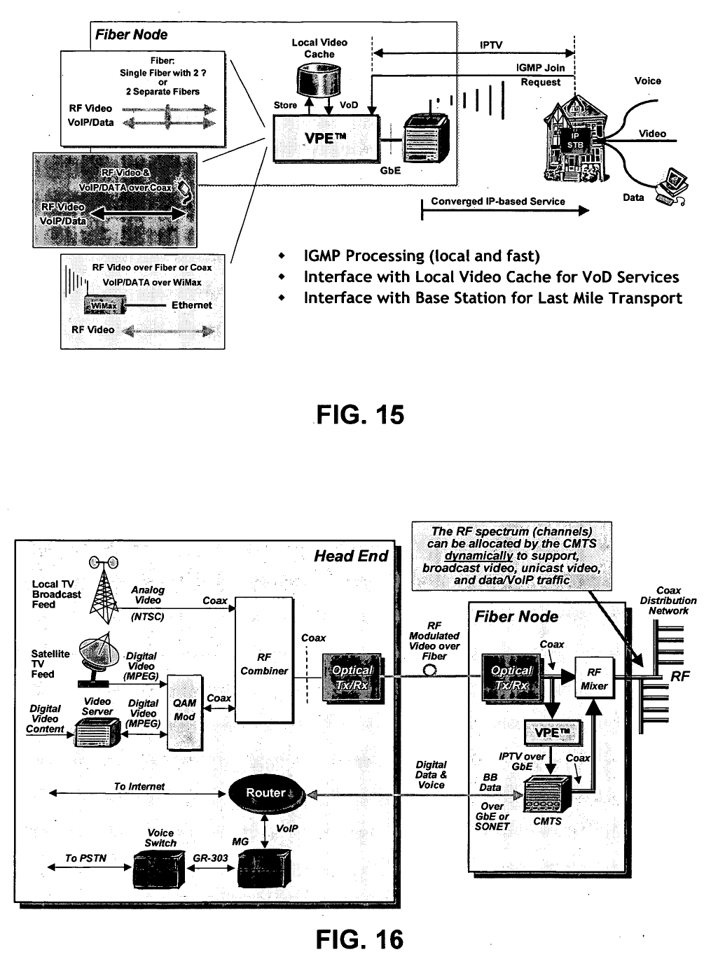

FIG. 15 illustrates an alternative embodiment that is designed for remote deployments, which may be useful for sites where extending coaxial cable might be too costly or otherwise not feasible. In this embodiment the video processing engine typically resides in a fiber node if fiber is used as the network feed, although any long haul transport feed is possible. The video processing engine performs bulk tuning on the video traffic as described herein, converts all types of traffic to base-band in IP form, and forwards the flows to a wireless base station (BS) that is co-located. Last mile transport is then handled by the BS over fixed wireless links. Voice and data flows are forwarded transparently to the BS based on IP addresses, and video flows are forwarded to the BS based on IGMP messages—effectively marrying the best of IPTV technology (over wireless) with RF technology. Advantageously, remote sites heretofore unreachable can be accessed by the MSOs, thus expanding the market for the CATV.

As with the previous solution, last mile transport is basically point-to-point without sacrificing the efficiency and cost-effectiveness of RF-based network feed and without limiting the wide program selection on a cable system. The end-user also receives all services over IP packets, allowing for full convergence of services in the IP paradigm.

Therefore, for both embodiments, shown in FIGS. 14 and 15, the video processing engine terminates the physical layer on the fiber or coaxial link, extracts the individual 6-MHz channels from the RF spectrum based on bulk tuning, processes the broadcast video payload, creates individual video streams, and makes them all available in a digital form. For the case of xDSL or Ethernet last mile, the video streams can be made available to the DSLAM or Ethernet switch, which sends the video signal to the end users over the last mile wireless loop. The wireless communication can be implemented according to the 802.16(a) standard or similar next generation non-line-of-sight fixed wireless technology. Multiple sectors can be used to provide the high bandwidth requirements of video. For the case of wireless last mile, the video streams can be made available to the BS, which sends the video signal to the end users over the last mile wireless loop.

In either case, video signaling may be initiated by the user by transmitting an IGMP message to the video processing engine through the access system (e.g., DSLAM, Ethernet switch, or BS). The video processing engine interprets the IGMP message, determines which video broadcast stream is being requested, and directs its local switch fabric to forward the desired video broadcast stream to the user (via the adjacent access system). IGMP messages that relate to the unicast VoD service can be passed to an optional video cache, which stores movies and features. In this way, embodiments of the invention allow the MSOs to offer bundled triple-play services, including broadcast and SDV services over the existing copper infrastructure inside a building complex and to remote sites.

Video Over DOCSIS

The MSOs offer high-speed data services over the cable system using CMTS systems according to the DOCSIS specifications. In this approach, most of the spectrum (e.g., over 90%) is consumed by the downstream video broadcast, which is transported over statically assigned RF channels (sub-carriers). A handful of channels are reserved for data and used by the CMTS to offer bi-directional data service. In this approach, the RF spectrum is divided between video service and data service, with no correlation between the two services at the user plane level or at the control plane level. Since the data signal and the video signal are combined at the physical RF level, correlation is not possible.

The bulk tuning techniques described herein can be employed in a DOCSIS network architecture to provide video services to subscribers, as shown in FIG. 16. This network architecture allows the MSOs perform bandwidth management (i.e., dynamic channel assignment) over the last mile coaxial network and allows the MSOs correlate video and data services using the IP layer as the command and control layer. As shown in FIG. 16, the network architecture serves a video service that runs on top of the DOCSIS system rather than adjacent to it. In other words, the entire RF spectrum becomes available for the CMTS system, and video is injected in IPTV form through the CMTS system. In this network architecture, the CMTS system becomes the central point for all services (voice, high-speed data, and video) for the MSOs.

Because the video channels arriving at the fiber node in RF-modulated form, they are converted into base-band form before they are injected into the DOCSIS protocol stack. The video processing engine tunes to all the RF-modulated video channels and extracts all the video streams. In this way, the video processing engine acts as a gateway between the RF-modulated video domain and the IPTV video domain. Adding to the flexibility available to the MSOs, this network architecture allows the MSOs to offer differentiated triple-play services to subscribers with different capabilities to better match the tiered nature of video service. It also gives the MSOs flexibility in directing any video program stream to any channel going to any user (or collection of users) on the fly, thus improving the MSO's ability to handle bandwidth allocation over the last mile coaxial network. The MSO also has the ability to correlate among voice, data, and video services at the IP layer, since all is in IP format, and the MSO can offer more advanced and interactive IP-based services. These features improve the ability of the MSOs to compete with the carriers and offer IP-based triple-play services.

Set-Top-Box (STB) for a Satellite TV System

Satellite video services have been deployed for decades with great success. In one embodiment of the invention, the bulk tuning techniques are employed in a satellite TV network architecture, where video content is sent over an uplink to an orbiting satellite. The satellite broadcasts the entire video content over one or more downlinks to cover a large serving area (e.g., many countries). Video is transported in digital MPEG format to the satellite and down to the subscriber's satellite dish. One problem that is inherent in existing satellite networks is the slow response time for changing a channel in the user's STB (called the zapping time). This time is caused by the frequency tuning in the STB, since the video content is frequency-modulated and must be captured and extracted. The delay is further added by the MPEG decoding in the STB to turn the digital signal into the analog format expected by the TV set.

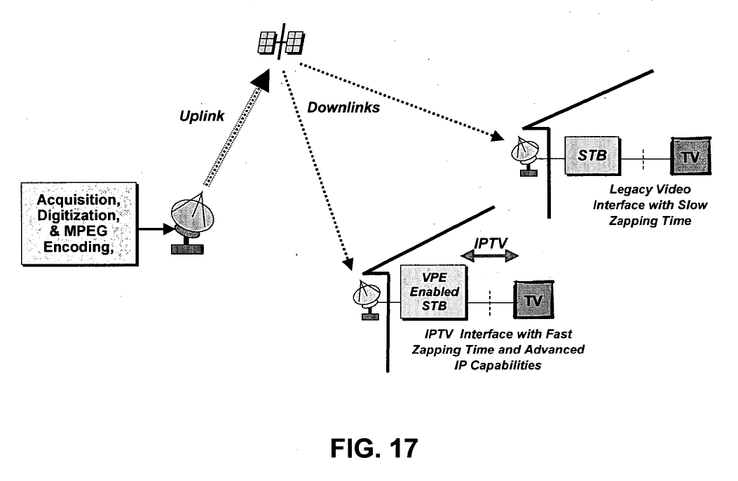

To avoid these problems, a video processing engine is employed as a front-end of the STB, as shown in FIG. 17. Using bulk tuning technology, both of these causes of delay can be resolved. The video processing engine receives L-Band video signal from the satellite dish, performs bulk tuning on all channels in the L-Band spectrum, and performs MPEG decoding of selected program streams. This architecture effectively turns the broadcast satellite video service into an IPTV video service at the customer premises. With the ability to tune and decode multiple program streams simultaneously (e.g., on the order of 32 to 64 program streams), the zapping time delay is virtually eliminated and channel changes can occur almost instantaneously.

Moreover, since video is now in IP format, advanced value-added IP-based services are made possible. Using bulk tuning technology offered by the video processing engine, the broadcast satellite service providers can write/download massive contents of information (e.g., video streams) in a local personal video recorder (PVR). In this way, the satellite TV providers can offer the subscriber VoD functionality. The write/download of the content into PVRs can be scheduled periodically (e.g., once per week, month, or other period). As a result, the broadcast service providers do not need to broadcast the content constantly, as is the case for premium channels where the content is being broadcasted repeatedly. Eliminating the need to broadcast the premium channels repeatedly, the L-band channel capacity is tremendously increased, thus freeing bandwidth capacity for the satellite broadcast service provider to offer other premium features.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

1. A method for terminating frequency-modulated video signal for delivery of video service to a subscriber, the method comprising:
receiving a frequency-modulated video signal, the video signal containing a plurality of frequency channels having digital video content modulated therein;
converting the received video signal from the analog to the digital domain;
extracting a plurality of channels from the video signal by using de-channelization in the digital domain; and
demodulating the digital video content from the extracted channels to produce a plurality of encoded digital video program streams.

2. The method of claim 1, further comprising:
tuning to a plurality of wideband frequency band portions of the received video signal, each wideband frequency band portion containing a subset of the channels in the received video signal,
wherein the converting, extracting, and demodulating are performed in parallel on the wideband frequency band portions of the received video signal in a plurality of parallel video pipes.

3. The method of claim 2, wherein the tuning comprises band pass filtering the received video signal and performing down conversion on the filtered video signal.

4. The method of claim 2, wherein the tuning is performed in the analog domain.

5. The method of claim 1, wherein extracting a plurality of channels from the video signal uses a poly-phase technique.

6. The method of claim 1, wherein the demodulating is performed using QAM demodulation.

7. The method of claim 1, wherein the demodulating is performed using quadrature phase shift keying (QPSK) demodulation.

8. The method of claim 1, further comprising:
performing forward error correction (FEC) on the video program streams.

9. The method of claim 1, wherein two or more of the program streams are multiplexed, further comprising:
serializing the multiplexed program streams based on a program ID (PID) value associated with each program stream.

10. The method of claim 1, further comprising:
encapsulating at least one of the video program streams into a series of IP packets.

11. The method of claim 1, wherein the received frequency-modulated video signal is in the radio frequency (RF) spectrum.

12. The method of claim 1, wherein the received frequency-modulated video signal is in the satellite L-band spectrum.

13. The method of claim 1, further comprising:
interfacing with subscriber distribution equipment for delivery of the program stream to a subscriber.

14. The method of claim 13, wherein the subscriber distribution equipment comprises a DSLAM.

15. The method of claim 13, wherein the subscriber distribution equipment comprises a base station for communication with a subscriber system over a wireless medium.

16. The method of claim 13, wherein interfacing comprises communication with a subscriber system over a point-to-point Ethernet connection.

17. The method of claim 1, further comprising:
receiving a control message from a subscriber requesting a particular video program stream; and
responsive to the control message, selecting the requested program stream for delivery of the program stream to the subscriber.

18. The method of claim 17, wherein the control message is in a format according to the Internet Group Management Protocol (IGMP).

19. A video processing engine for terminating frequency-modulated video signal for delivery of video service to a subscriber, the video processing engine comprising:
an interface for receiving a frequency-modulated video signal, the video signal containing a plurality of frequency channels having digital video content modulated therein;
an analog to digital converter for converting the received video signal from the analog to the digital domain;
a digital tuner coupled to the analog to digital converter for extracting a plurality of channels from the video signal by using de-channelization in the digital domain; and
a demodulator coupled to the digital tuner for demodulating the digital video content from the extracted channels to produce a plurality of encoded digital video program streams.

20. The video processing engine of claim 19, further comprising:
a plurality of video pipes, each video pipe including an instance of the analog to digital converter, and instance of the digital tuner, and an instance of the demodulator, each video pipe further including an analog tuner coupled to the interface for tuning to a plurality of wideband frequency band portions of the received video signal, each wideband frequency band portion containing a subset of the channels in the received video signal,
wherein each video pipe receives and processes one of the wideband frequency band portions of the received video signal in parallel with the other video pipes.

21. The video processing engine of claim 20, wherein the analog tuner of each video pipe tunes to a wideband frequency band portion of the video signal by band pass filtering the received video signal and performing down conversion on the filtered video signal.

22. The video processing engine of claim 20, wherein the analog tuner of each video pipe tunes to a wideband frequency band portion of the video signal in the analog domain.

23. The video processing engine of claim 19, wherein the digital tuner extracts a plurality of channels from the video signal uses a poly-phase technique.

24. The video processing engine of claim 19, wherein the demodulator demodulates the extracted channels using QAM demodulation.

25. The video processing engine of claim 19, wherein the demodulator demodulates the extracted channels using quadrature phase shift keying (QPSK) demodulation.

26. The video processing engine of claim 19, further comprising:
a forward error correction module coupled to receive one or more of the demodulated video program streams, the serialization module configured to perform forward error correction on the video program streams.

27. The video processing engine of claim 19, further comprising:
a serialization module coupled to receive one or more of the demodulated video program streams, the serialization module configured to serialize two or more multiplexed program streams based on a program ID value associated with each program stream.

28. The video processing engine of claim 19, further comprising:
an encapsulation module coupled to receive one or more of the demodulated video program streams, the encapsulation module configured to encapsulate at least one of the video program streams into a series of IP packets.

29. The video processing engine of claim 19, wherein the interface is configured to receive the frequency-modulated video in the radio frequency (RF) spectrum.

30. The video processing engine of claim 19, wherein the interface is configured to receive the frequency-modulated video in the satellite L-band spectrum.

31. The video processing engine of claim 19, further comprising:
a switching circuit for selecting a particular video program stream for delivery to a subscriber.

32. The video processing engine of claim 31, further comprising:
a subscriber interface coupled to receive video program streams from the switching circuit, the subscriber interface for delivering one or more video program streams to a subscriber.

33. The video processing engine of claim 32, wherein the subscriber interface communicates with a DSLAM for delivering video program streams to subscribers.

34. The video processing engine of claim 32, wherein the subscriber interface communicates with a fixed wireless base station for delivering video program streams to subscribers.

35. The video processing engine of claim 32, wherein the subscriber interface communicates over a point-to-point Ethernet connection for delivering video program streams to subscribers.

36. The video processing engine of claim 32, wherein the subscriber interface is configured to receive control messages from a subscriber requesting a video program stream, and, responsive to the control messages, the switching circuit provides the requested video program stream to the subscriber interface for delivery of the requested video program stream to the subscriber.

37. The video processing engine of claim 36, wherein the control message is in a format according to the Internet Group Management Protocol (IGMP).

38. A system for providing video service to a plurality of subscribers, the system comprising:
an interface for receiving a frequency-modulated video signal containing a plurality of video program streams from a service provider;
means for extracting a plurality of channels from the frequency-modulated video signal;
means for demodulating the extracted channels to produce a plurality of encoded video program streams; and
a subscriber interface for delivering video program streams to at least some of the plurality of subscribers.

39. The system of claim 38, wherein the subscriber interface is configured to receive control messages from the subscribers requesting video program streams, responsive to which control messages the subscriber interface delivers the requested program streams to the subscribers.
